(19) United States
(12) Patent Application Publication
(10) Pub. No.: US 2005/0123669 A1
(43) Pub. Date: Jun. 9, 2005

(54) Nutritional supplement of garlic and yolk mixtures

(76) Inventor: Ichiro Yamada, Kurume-city (JP)

Correspondence Address: PITNEY HARDIN LLP, 7 TIMES SQUARE, NEW YORK, NY, 10036-7311, US

(21) Appl. No.: 11/006,276

(22) Filed: Dec. 7, 2004

(30) Foreign Application Priority Data
Dec. 8, 2003 (JP) JP2003-408805

(51) Int. Cl. A23L 3/00

(52) U.S. Cl. 426/614

(57) ABSTRACT

As natural ingredients are used in the production of the garlic-yolk product, it has been impossible to keep the delicate balance in the final product. It has brought differences in the quality of the final product depending on the garlic's level of oxidation, maturity, time of harvest, place of growing, etc. As a result, the color, taste and smell were varying, and the only solution has been the usage of PH-adjusters, artificial coloring and aroma, stabilizers, in the form of chemicals and other kinds of additives. In order to solve the problem of dispersed quality, I use a natural material extracted from natural garlic, which richly contains water-soluble organic sulfur compound S-allylcysteine. This material is added to the garlic-yolk mixture after cooling it down to normal temperature. As a result, this material eliminates the differences of garlic and stabilizes the quality of the final product. All this, by using natural ingredient only.

### TECHNOLOGY FIELD

This invention relates to a nutritional supplement of garlic and egg yolk mixtures and a method of making such a nutritional supplement of garlic and egg yolk mixtures.

### BACKGROUND TECHNOLOGY

The nutritional supplement made of garlic and yolk by stirring and heating them up together has long been prepared in everyday life. It can easily be consumed and is recently sold in commerce. It is now mainly being produced in large scale processing factories because the product should frequently be stirred and because of the strong smell.

There are products on the market, which are made of a garlic and yolk composite. These products however contain further nutritive foods and additives, which might make them effective in a wider range, but they do not take into consideration the delicate balance between garlic and yolk, the garlic's level of oxidation, the maturity of the garlic, the differences emerging from the place of production, etc. In order to compensate the above problems, there has been no other way so far, but the usage of PH stabilizers, artificial coloring and aroma, and other kinds of drugs/chemical additives.

### SUMMARY OF THE INVENTION

In order to solve the problem of quality dispersion, aged garlic powder (AGP), a mixture of water-soluble organic sulphur compounds including a substantial amount of S-allylcysteine (SAC) is added to garlic and yolk mixtures after heating. As a result, the difference resulting from the different garlics disappears, and the problem is solved without the usage of further additives.

### BRIEF DESCRIPTION OF THE DRAWINGS

The above mentioned objects and advantages of the present invention, as well as additional objects and advantages thereof, will be more fully understood hereinafter as a result of a detailed description of preferred embodiments when taken in conjunction with the following drawings in which:

FIG. 1 shows different methods of processing fresh garlic and its resulting products;

FIG. 2 shows a process of producing S-allylcysteine (SAC) gradually with the aid of enzyme γ glutamyl transpeptidase; and

FIG. 3 shows microscopic pictures of a blood sample taken before, 10 minutes, 20 minutes and one hour after the user took final products of the present invention.

### DETAILED DESCRIPTION OF PREFERRED EMBODIMENTS

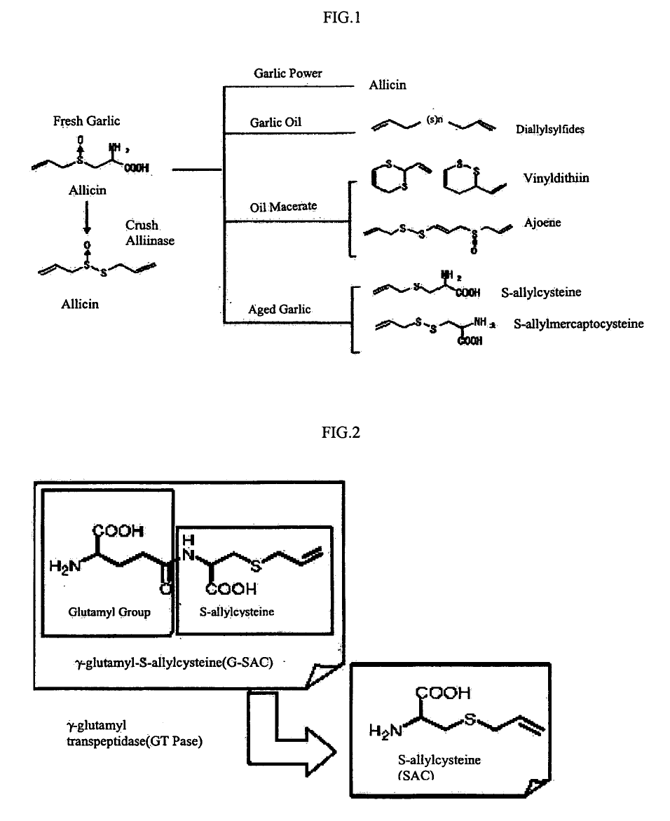

In essence, the main ingredients of garlic comprises 60% of water, 30% of suger, 8% of protein and 1% of sulfur compounds such as trisulfide. As one of features of garlic, garlic final products are different in kind and amount of constitutional components and thus different in nutritional benefits, depending on methods of processing fresh garlic. This is because reactions of enzymes such as alliinase existing in fresh garlic and individual precursors are highly susceptible to changes in the methods of processing fresh garlic. FIG. 1 shows different methods of processing garlic and characteristic sulfur organic compounds included their final products.

Conventionally, methods of processing garlic are classified into four categories: (1) reduce fresh garlic into powder after drying (garlic powder), (2) distill fresh garlic with steam (garlic oil), (3) mince fresh garlic in vegetable oil (oil macerate), and (4) age fresh garlic for a long period (aged garlic). In method (1), allicin still exists and alliinase remains bioactive depending upon the processing conditions such as dry temperatures. Major components of final products in method (2) are allyl sulfides and the counterparts in method (3) are vinyldithiin and ajoene. Final products of method (4) are featured by inclusion of water-soluble sulfur compounds such as S-allylcysteine (SAC) and S-allylmercaptocysteine (SAMC). The present invention is to propose a new and useful category of garlic processing method.

According to the present invention, fresh garlic and egg yolk are mixed and heated for a long time (for example, approximately eight hours) and then aged garlic powder (AGP) is added to the garlic and egg yolk mixtures. The AGP is added only after the temperature of the garlic and yolk mixture becomes lower to a certain extent. The reason why the AGP can not be added at higher temperatures is that the main objective of the AGP addition is S-allylcysteine (SAC) which is heat sensitive and may suffer damage if added to during or immediately after heating of the garlic and yolk mixtures.

The garlic and yolk components are mixed together and then heated for a long time in order to create new materials through heating. For example, such new materials include lipid allicin developed by bonding allicin of garlic and lipid of yolk together, disurfides and trisurfides both developed by bonding lipid allicin and sulfur components of garlic and ajoene (in a slight amount).

The present invention incorporates into fmal garlic products both materials which might have been lost during heating and materials which might have been developed during heating. Pursuant to the present invention, the former materials are filled with addition of the AGP after heating. In another aspect of the present invention, both water-soluble sulfur compounds and oil-soluble sulfur compounds are incorporated into the final garlic products. Heat sensitive materials such vitamins C and E originally in existence in fresh garlic are already lost during heating. Vitamins B1 and B2 are also damaged and lost during heating, though they are expected to survive only in an appreciable amount during heating. If the AGP has been added during or immediately after high temperature heating, S-allylcysteine (SAC) would have been damaged and lost.

It has recently been revealed that garlic components include “volatile organic sulfur compound” having garlic odor and many other compounds. S-allylcysteine (SAC) is odorless amino acid having sulfur atoms and is saved in fresh garlic as γ glutamyl S-allylcysteine (G-SAC) and developed gradually with the aid of enzyme γ glutamyl transpeptidase existing in fresh garlic, when fresh garlic is sliced, grinded, clashed or aged. FIG. 2 illustrates this process of development of S-allylcysteine (SAC). Allyl sulfides are representative components for “oil-soluble volatile organic sulfur compounds” having garlic odor, whereas S-allylcysteine (SAC) is a representative component for “water-soluble, non-volatile organic sulfur compound having no garlic odor. It has recently been reported that S-allylcysteine (SAC) has a variety of pharmacological activities in animal tests and the effect of suppressing oxidized form LDL (low density lipoprotein) in cultured cell tests. See, for example, http://www.nutrition.org/cgi/content/, http://www.wakunaga.co.jp/garlic/

As garlic-yolk products have recently been widely sold in commerce, the quality is a crucial point. The main ingredients of garlic-yolk products consist of garlic and yolk. Thus, the differences resulting from the particular ingredients used cause an unstable quality. In order to solve this problem, PH adjustment, artificial color and aroma, stabilizer and other chemical additives were to be used in the past, but from the customer's point of view this should be avoided.

The product according to the present invention eliminates the usage of chemical modifiers, and assures an equal quality by adding water-soluble organic sulphur compound S-allylcysteine (SAC), which is extracted from naturally ripened garlic (AGP). In this way, the garlic components can be regulated, and the finished product is of equal quality.

Naturally aged garlic powder (AGP) is ripening of fresh garlic with the aid of enzyme in bacteria, especially SP germ under “dark and cold” conditions instead of saving and ripening of fresh garlic under pressure, vacuum or overheating conditions. Nutrients that are originally contained rich in fresh garlic but may be damaged or lost during heating of garlic are vitamin B group including vitamin B1, vitamin C, folic acids and amino acids. Out of water-soluble organic sulfur compounds, γ glutamyl S-allylcysteine (G-SAC) is a so-called precursor for S-allylcysteine (SAC), which is originally contained in fresh garlic but is expected to be damaged or lost during overheating of garlic. Naturally aged garlic powder (AGP) needs a long time of aging (for example, three years) where γ glutamyl S-allylcysteine (G-SAC) is dissolved into S-allylcysteine (SAC) and S-allylmercaptocysteine (SAMC) with the power of enzyme in SP germ.

As the water-soluble organic sulfur compound S-allylcysteine (SAC) is originally contained in naturally ripened garlic (AGP), it strengthens the effects of garlic-yolk products. Although the nutritive values, the amounts of various vitamins, amino acids and proteins etc. can be reduced during heating of fresh garlic, the use of the water-soluble organic sulfur compound S-allylcysteine (SAC) compensates for such reductions and keeps them at higher levels. The nutrients and effective components of garlic that are originally contained in garlic but to be lost due to heating, such as vitamin group B, vitamin C, folic acids, γ glutamyl S-allylcysteine (G-SAC), are compensated for and recovered through the addition of the aged garlic powder (AGP).

As the water-soluble organic sulfur compound S-allylcysteine (SAC) is a material extracted from the aged garlic powder (AGP) in a completely natural way, it also helps the developing of materials that would normally hardly be produced or mixed with each other.

Comparing the final products of the present invention to conventional ones made of garlic only, reveals that the particular taste and odor of garlic is controlled in the garlic-yolk products of the present invention.

The aged garlic powder (AGP) including a substantial amount of the water-soluble organic sulfur compound S-allylcysteine is added to the garlic-yolk mixtures while paying attention to the temperature control.

The basic concepts of the present invention have been discussed briefly in the foregoing description and specific embodiments of the present invention will now be discussed in the following description.

### PRACTICAL EXAMPLE 1

The following description will set forth an example of a process of manufacturing a nutritional supplement food and it should be noted that the words and expressions used herein are mere explanatory and not-limiting and not intended to exclude words and expressions that set forth features and characteristics of the present invention or their equivalents. Modifications which fall within the spirit and scope of the invention may be made and covered by claims at the end of the specification.

I peel fresh garlic and mash 10,000 g of fresh garlic in a mixer, I add 2,000 g of yolk and thoroughly mix. Then, I place the mixture in an iron pan, and heat the pan until the surface temperature of the bottom of the pan reaches 120° C. while paying attention so that it does not burn down. As water evaporates, the ingredients start to turn brown. At the same time, viscosity is increased and in about six (6) hours, the garlic-yolk mixture will turn into solid ball shapes.

It is obvious in the relevant art that the mixing ratio of yolk to garlic is flexible and may be changed within a wide range, for example, up to 10:10 or down to 0.5:10. I may add 1,000 g of yolk to 10,000 g of fresh garlic as another example of the present invention. A temperature of 120° C. is selected as a temperature where garlic will not burn down and without losing its nourishment to a substantial extent and a temperature higher or lower than 120° C. may be used for the purposes of the present invention as long as those requirements are met. While the period of garlic heating is set forth as six (6) hours in the above practical example, it may be eight (8) hours or longer.

Here, I stop heating for a while, leave it so that it cools down to normal temperature. Then, I add 100 g of aged garlic powder (AGP) rich in S-allylcysteine (SAC). I experience the formation of “brownness” and odor. More particularly, after heating of the mixer for mixing garlic and yolk is stopped and cooled to normal temperature, the aged garlic power (AGP) is added to the garlic yolk mixture in the same mixer by stirring.

Aged garlic powder (AGP) is commercially available from JMC Co., LTD., 4-16-8 Minami-Ikebukuro, Toshima-ku, Tokyo, 170-0022, Japan, http://www.jmc-co.com. The aged garlic powder (AGP) includes not only S-allylcysteine (SAC) but also other organic sulfur compounds such as S-allylmercaptocysteine (SAMC) and γ glutamyl S-allylcysteine (G-SAC). The amount of S-allylcysteine (SAC) in the aged garlic powder (AGP) from JMC Co., LTD. is 1,114 mg per 1 g (that is, 0.114%) on average. The aged garlic powder (AGP) from JMC uses the SP germ or bacteria to develop S-allylcysteine (SAC). Another way to extract S-allylcysteine (SAC) from garlic is to dip garlic in alcohol as solvent. Kyolic (liquid form of Aged Garlic Extract, AGE) from Wakunaga Pharmaceutical includes only 0.01% of S-allylcysteine (SAC).

In addition to this, I add 400 g of aged garlic powder (AGP) rich in S-allylcysteine, so that total added amount is 500 g. I experience no change in “brownness” and odor. I further add 500 g of aged garlic powder (AGP) rich in S-allylcysteine (SAC), so that the total amount of aged garlic powder (AGP) is 1,000 g, but the “brownness”, taste and odor do not change.

Water-soluble organic sulphur compounds like S-allylcysteine (SAC) have very weak heat resistance. Thus, if I decompress it at normal temperature for two days while drying it, the result is that I succeed in bringing “brownness”, taste and smell to an equal level, no matter whether I added 100 g, 500 g or 1,000 g.

As the heat resistance of S-allylcysteine (SAC) is weak, temperature control is a crucial point when adding it to the garlic-yolk mixture. That is why S-allylcysteine (SAC) should be added only after processing the garlic-yolk mixture into powder.

It is seen from the experiment that if the temperature of the mixture already containing the compound material rich in S-allylcysteine (SAC) is not increased above 70° C., the S-allylctsteine amount contained in the product does not diminish.

Plant Bioactives Research Institute, 95 South Mountain Way Drive, Orem, Utah 84058 carried out analysis on the final garlic-yolk product made according to the present invention with the results of the following ingredients or content.

| INGREDIENTS | WEIGHT (mg/tablet) |
|---|---|
| Diallyl Disulfide | 0.009 |
| Methyl Allyl Trisulfide | 0.011 |
| Diallyl Trisulfide | 0.082 |
| Diallyl Teerasulfide | 0.021 |
| S-Allyl Cysteine | 0.057 |
| Alliin | 0.254 |

Ajoane, Allicin yield, Vitamin B1 and B2 possible trace.

In the foregoing table, 1 table is approximately 0.18 gram on average. Therefore, it is concluded that the final product contains 0.316 mg of S-Allyl Cysteine per 1 gram. Since it is recommended that the user takes 4 tables per day, the user may take approximately 1.27 mg of S-Allyl Cysteine.

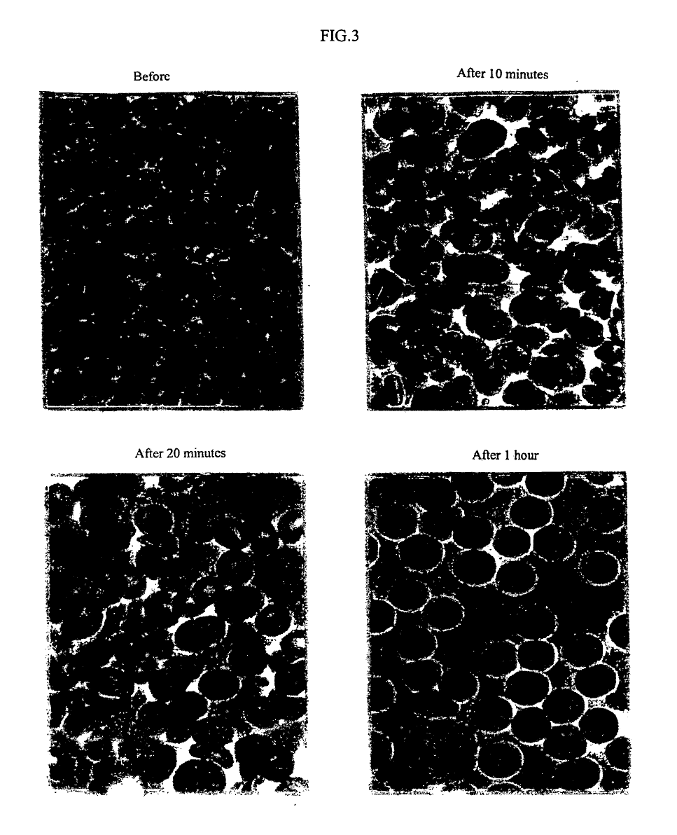

FIG. 3 shows microscopic pictures of a blood sample taken before, 10 minutes, 20 minutes and 1 hours after the user took the final products of the present invention. It is clear from those pictures that blood became fresh and smooth.

The following will set forth a conventional method of processing garlic-yolk products (without adding the aged garlic powder (AGP) as comparative example.

Same way as the method above, I peel fresh garlic and mash 10,000 g of fresh garlic in a mixer, I add 2,000 g of yolk and thoroughly mix. Then, I place the mixture in an iron pan, and heat the pan until the bottom of the pan reaches 120° C. while paying attention so that it does not burn down. As water evaporates, the ingredients start to turn brown. At the same time, viscosity is increased and in about 6 hours, the garlic-yolk mixture will turn into solid ball forms.

Now, even though I keep at the same level the amount of garlic and yolk, the temperature of the iron pan, the stirring speed, the heating time, the product I finally get will be varying in color, taste and smell.

Moreover, if I stop heating for a while, decompress it for two (2) days while drying it, it is still not possible to solve the problem of differences in color, taste and smell.

Yet, I call color the different nuances of brown, I call taste the different bitter, hot and mild tastes, and I call smell the characteristic smell of garlic.

### INDUSTRIAL USE

It has long been acknowledged by customers that the products made of garlic and yolk exercises a benign effect on one's physical condition. Both garlic and yolk have positive effects, but the mixture of these two components have an even more effective way, as they result in strengthening each other's effect.

However, if I take into consideration the length of the method of processing garlic, the natural differences that exist between the ingredients, I see that dispersion has occurred in the case of the final product so far. That is why chemicals and other additives have been used to stabilize the quality of the final product. Now I can see that it possible to achieve the same result by using only natural elements.

Also, the water-soluble organic sulphur compound S-allylcysteine is a material extracted directly from natural garlic, thus it can easily adjust the individual differences of garlic, and also effectively maintains the proportion of components. At the same time, it also controls the problem of color, taste and smell, thus offers an effective way to produce a garlic-yolk product of stable quality.

Those having skill in the art to which the present invention pertains will now, as a result of the applicant's teaching herein, perceive various modifications and additions which may be made to the invention. By way of example, the precise shapes shown and described herein may be readily altered in varying degrees while achieving the essential objectives of the invention. Accordingly, all such modifications and additions are deemed to be within the scope of the invention which is to be limited only by the claims appended hereto.

1. A nutritional supplement of a garlic and yolk mixture with addition of a water-soluble organic sulfur compound S-allylcysteine (SAC).

2. A nutritional supplement of a garlic and yolk mixture with addition of aged garlic powder (AGP) including a water-soluble organic sulfur compound S-allylcysteine (SAC).

3. A nutritional supplement of a garlic and yolk mixture with addition of aged garlic powder (AGP) including 1,114 mg per 1 g of a water-soluble organic sulfur compound S-allylcysteine (SAC).

4. The nutritional supplement of claim 2 wherein the aged garlic powder (AGP) is garlic powder naturally ripened under dark and cold conditions for a long time.

5. A nutritional supplement of a garlic and yolk mixture with addition of aged garlic powder (AGP) including a water-soluble organic sulfur compound S-allylcysteine (SAC), S-allylmercaptocysteine (SAMC) and γ glutamyl S-allylcysteine (G-SAC).

6. A nutritional supplement of a garlic and yolk mixture with addition of aged garlic powder (AGP) including a water-soluble organic sulfur compound S-allylcysteine (SAC) after heating of the garlic and yolk mixture.

7. A method of making a nutritional supplement, comprising the steps of:
adding garlic and yolk mixture at high temperature; and
adding water-soluble organic sulfur compound S-allylcysteine (SAC) to the garlic and yolk mixture at normal temperature to form a final garlic-yolk product as a nutritional supplement.

8. A method of making a nutritional supplement, comprising the steps of:
heating up garlic and yolk mixture;
cooling the garlic and yolk mixture down to normal temperature; and
adding water-soluble organic sulfur compound S-allylcysteine (SAC) to the garlic and yolk mixture to form a final garlic-yolk product as a nutritional supplement.

9. A method of making a nutritional supplement, comprising the steps of:
mixing fresh garlic and egg yolk together to form a garlic and yolk mixture;
heating the garlic and yolk mixture up to 120° C.;
cooling the garlic and yolk mixture down to normal temperature; and
adding water-soluble organic sulfur compound S-allylcysteine (SAC) to the garlic and yolk mixture to form a final garlic-yolk product as a nutritional supplement.

10. The method of claim 8 wherein the mixing rate of yolk to garlic is within 10:10 to 0.5:10.

11. The method of claim 7 wherein the garlic and yolk mixture is heated at a temperature where garlic will not burn down and without losing its nourishment to a substantial extent.

12. A method of making a nutritional supplement, comprising the steps of:
heating up garlic and yolk mixture;
cooling the garlic and yolk mixture down to normal temperature; and
adding aged garlic powder (AGP) including water-soluble organic sulfur compound S-allylcysteine (SAC) to the garlic and yolk mixture to form a final garlic-yolk product as a nutritional supplement.

13. A method of making a nutritional supplement, comprising the steps of:
heating up garlic and yolk mixture;
cooling the garlic and yolk mixture down to normal temperature;
adding aged garlic powder (AGP) including water-soluble organic sulfur compound S-allylcysteine (SAC) to the garlic and yolk mixture; and
repeating adding of aged garlic powder (AGP) to form a final garlic-yolk product as a nutritional supplement.

14. The method of claim 13 wherein 10,000 g of fresh garlic and 2,000 g of egg yolk are mixed together to form garlic and yolk mixture and a total of 1,000 g of the aged garlic powder (AGP).

15. A method of making a nutritional supplement, comprising the steps of:
preparing garlic and yolk mixture at high temperature; and
adding aged garlic powder (AGP) to the garlic and yolk mixture at low temperature to form a final garlic-yolk product as a nutritional supplement.

16. A nutritional supplement comprising the following ingredients:

| INGREDIENTS | WEIGHT (mg/tablet) |
|---|---|
| Diallyl Disulfide | 0.009 |
| Methyl Allyl Trisulfide | 0.011 |
| Diallyl Trisulfide | 0.082 |
| Diallyl Teerasulfide | 0.021 |
| S-Allyl Cysteine | 0.057 |
| Alliin | 0.254 |
